(19) United States
(12) Patent Application Publication
(10) Pub. No.: US 2007/0260516 A1
(43) Pub. Date: Nov. 8, 2007

(54) Method and system for billing for online advertisement delivery services

(76) Inventors: Michael A. Schoen, Tiburon, CA (US); Bruce M. Martin, San Mateo, CA (US); Michael L. Grubb, San Francisco, CA (US); Mark Kidwell, Oakland, CA (US); Michael S. Campbell, San Francisco, CA (US)

Correspondence Address: GREENBERG TRAURIG, LLP (SV2), 2450 Colorado Avenue, Suite 400E, Santa Monica, CA, 90404, US

(21) Appl. No.: 11/429,331

(22) Filed: May 5, 2006

(51) Int. Cl. G06Q 30/00

(52) U.S. Cl. 705/14

(57) ABSTRACT

A method and system for billing for online ad delivery services are disclosed. According to one aspect of the invention, an advertiser establishes an account with an online ad delivery service, and provides an initial amount of funds for the account. In addition, the advertiser establishes a budget limit for a specified budget period. As ads are served and clicked by end-users, a predetermined fee is debited from the advertiser's account. However, the ad server includes budget analysis logic to determine when to stop serving ads to ensure that the advertiser's budget limit is not exceeded, thereby ensuring that the advertiser's initial funds are not used up more quickly than desired.

### TECHNICAL FIELD

Embodiments described herein generally relate to online advertisement delivery services. In particular, the embodiments relate to a method and system for billing for online advertisement delivery services.

### BACKGROUND

Advertisers have discovered that the Internet, and the World Wide Web in particular, provides an excellent platform for reaching potential customers. To serve advertisers' needs, companies devoted to serving online advertisements have developed methods and techniques allowing advertisers to carefully target the proper audience with their ads. For example, Internet advertisement service providers enable advertisers to target specific audiences by matching advertisements with keyword searches and/or the content of a particular web page.

One of the problems with services offered by many online advertisement service providers is that the service offerings can be complicated and difficult for the advertiser to understand. In particular, many services require significant up front costs. In addition, the fee arrangements are often structured such that the advertiser cannot predict the cost of the service with any reasonable amount of certainty. For example, because it is virtually impossible to predict the frequency with which certain keywords are going to be searched or appear on web pages, it is extremely difficult to predict the number of times a particular advertisement will be served and clicked by an end-user. Consequently, in a conventional pay-per-click (PPC) system, advertisers are often charged significantly more in advertising fees than expected.

### SUMMARY OF THE DESCRIPTION

The present invention overcomes the problems in the existing art described above by providing a method and system for billing for online advertisement delivery services. According to one embodiment of the invention, an advertiser may generate an account with an online advertisement service provider and provide an initial amount of funds for the account. In addition, the advertiser may establish a budget limit representing a maximum amount of funds to be debited from the account in a given budget period in connection with advertisement related services. As the advertisement server serves advertisements and end-users click the ads, a predetermined fee is debited from the advertiser's account, for example, when the end-users click the ads. The ad server may include a budget analyzer that determines when the amount of funds debited from the advertiser's account is approaching the advertiser's established daily budget. Accordingly, the ad server may stop serving advertisements associated with the advertiser's account, when it is determined that an additional ad, if served and clicked, will result in fees for a given day exceeding the budget limit established by the advertiser. Alternatively, the advertisements may continue to be served, but the advertiser will not be charged (for the period remaining in the budget period), in response to an advertisement being selected by an end-user. Additionally, the invention is equally applicable where the fee debited from the advertiser's account is charged when the advertisement is displayed; when the advertisement is clicked on; when the advertisement is clicked on and there is a subsequent sales call or direct contact with the end-user; or when the advertisement is clicked on and there is a subsequent sale, signup, enrollment, pledge, or other affirmative activity of the end-user.

### BRIEF DESCRIPTION OF THE DRAWINGS

Embodiments are illustrated by way of example and not by way of limitation in the figures of the accompanying drawings in which like references indicate similar elements, and in which:

FIG. 1 illustrates a network environment in which an embodiment may be implemented;

FIG. 2 illustrates an example of a web page with a targeted advertisement served from an ad server, according to an embodiment;

FIG. 3 illustrates a logical block diagram of an ad server, according to an embodiment;

FIG. 4 illustrates a method for billing for advertisement services, according to an embodiment;

FIG. 5 illustrates the operations involved in a method for billing for advertisement services, according to an embodiment; and

FIG. 6 illustrates an example of a computing system, with which an embodiment might be implemented.

### DETAILED DESCRIPTION

The following provides a detailed description of a method and system for billing advertisers for online advertisement services. In the following description, for purposes of explanation, numerous specific details are set forth in order to provide a thorough understanding of the present invention. It will be evident to one skilled in the art, however, that the present invention may be practiced without these specific details. The description and representation herein are the means used by those experienced or skilled in the art to effectively convey the substance of their work to others skilled in the art. In some instances, to avoid unnecessarily obscuring tangential aspects of the present invention, well-known operations and components have not been described in detail.

Reference herein to “one embodiment” or “an embodiment” means that a particular feature, structure, operation, or other characteristic described in connection with the embodiment may be included in at least one implementation of the invention. However, the appearance of the phrase “in one embodiment” or “in an embodiment” in various places in the specification does not necessarily refer to the same embodiment.

In one embodiment of the present invention, an online advertisement service provider operates an ad server that enables advertisers to target specific audiences with ads. Accordingly, after an advertiser has established an account with the online advertisement service provider and generated one or more advertisements to be served, a billing increment, minimum balance, and budget limit may be determined. The billing increment is the amount that the advertiser pays up front for the service. For example, the advertiser may provide a credit card number to the online advertisement service provider, so as to transfer funds from the advertiser's credit card account to an account held with the online advertisement service provider. The budget limit is the maximum amount that the advertiser authorizes to be debited against the advertiser's account in a given budget period (e.g., one day), in connection with services provided by the online advertisement service provider. In one embodiment of the invention, once the advertiser's account reaches a predetermined minimum balance, the advertiser's credit card is charged an amount equal to the billing increment in order to replenish the funds in the advertiser's account.

For example, an advertiser may initially select a billing increment of $100 and a daily budget of $20. Accordingly, when the ad server serves an advertisement associated with the advertiser's account and a billable event occurs; for example, when an end-user clicks, or selects, the advertisement, a predetermined amount of funds will be debited from the advertiser's account (e.g., $2.00). Alternatively, the advertiser is charged when the ad server serves an advertisement associated with the advertiser's account.

The ad server monitors the number of billable events, such as clicks associated with the advertiser's ads, and after ten end-users have clicked on advertisements of the advertiser in a given day, the daily budget of $20 is reached (e.g., 10 clicks at $2.00/click is $20.00). Consequently, the ad server recognizes that the budget limit has been reached and no longer serves advertisements associated with the advertiser's account, thereby ensuring that the budget limit is not exceeded. In one embodiment, the ad server is able to predict that an additional debit will exceed the budget limit, before the budget limit is actually reached. Accordingly, the ad server will stop serving advertisements to ensure that the amount debited does not exceed the budget limit. Alternatively, the advertisements will be continued to be served, but the advertiser will not be charged (for the period remaining in the budget period), in response to an advertisement being selected by an end-user. In another embodiment, the ad server is unable to predict that an additional debit will exceed the daily budget before the daily budget is reached. Accordingly, the ad server will stop serving ads as quickly as it can and will not charge for those excess ads so that the amount debited does not exceed the daily budget.

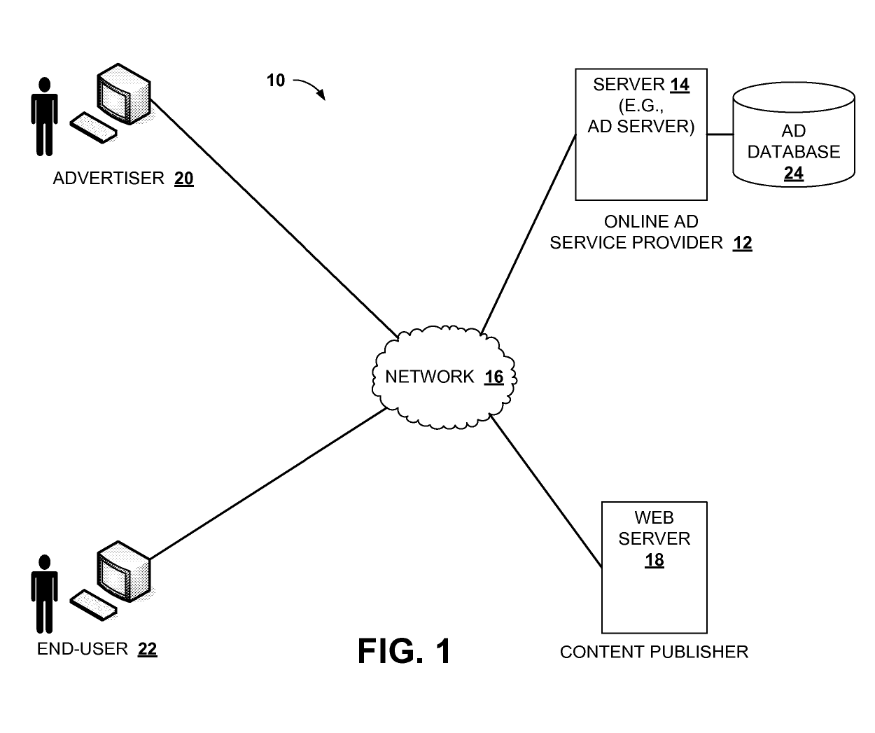

FIG. 1 illustrates a network environment 10, in which an online ad server 14, according to an embodiment, may operate. As illustrated in FIG. 1, the online advertisement service provider 12 operates a server 14 (e.g., ad server) that is connected by means of a network 16 (e.g., such as the Internet) to a web server 18 of at least one content publisher 20. In addition, both the ad server 14 and the publisher's web server 18 are accessible to advertisers and end-users via client computers (e.g., advertiser client 20 and end-user client 22.)

Generally, the ad server 14 provides a number of services to assist an advertiser in generating an ad, and targeting an audience for the ad. For example, after establishing an account with the online advertisement service provider 12, the advertiser may generate one or more ads. In one embodiment, the ad server 14 may facilitate the generation of the advertisement with online editing tools. In any case, after the advertisement has been generated, the advertiser associates the advertisement with one or more keywords. In one embodiment of the invention, the advertiser bids against other advertisers for the keywords in an electronic auction, facilitated by the ad server 14. Assuming the advertiser bids a sufficient amount, the advertiser wins the right to have the keywords associated with his or her ad.

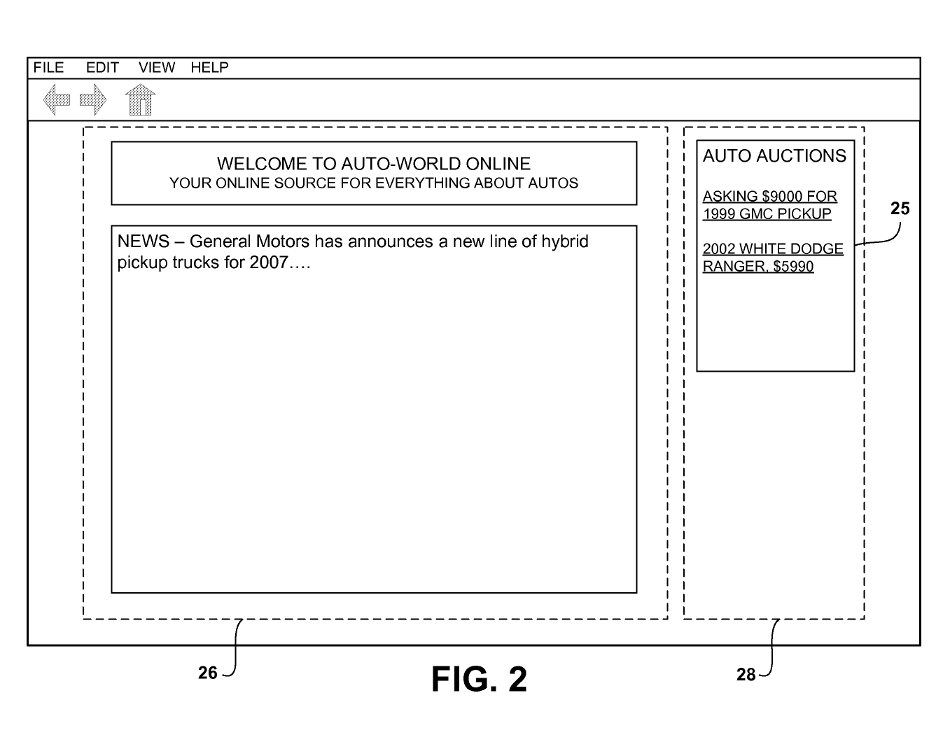

FIG. 2 illustrates an example of a web page 25 with a targeted advertisement 27 served from an ad server 14, according to an embodiment. For example, an automobile dealer may generate an advertisement 27 listing autos for sale, and then associate the advertisement 27 with the keyword, “autos” and/or “pickup.” Accordingly, the ad server 14 may serve that particular advertisement 27 when the content of a publisher's web page 25 includes the keyword(s) associated with the ad. If, for example, an end-user 22 requests a web page from the content publisher's web server 18, and the web page includes content related to autos, the ad server 14 may place or serve the advertisement alongside the content related to autos. In FIG. 2, for example, the web page 25 includes a content portion 26, served from the content publisher's web server 18, and an advertisement portion 28, served from the ad server 14. Typically, the ad server 14 will select the particular advertisement to serve based, in part, on the textual content of the content portion 26 of the web page 24. (The textual content may include both the visual portion, as well as any meta-data that is not visible to the end-user.) Alternatively, the ad server 14 may select the particular advertisement to serve based on a keyword search performed by the end-user.

An ad, such as that illustrated in FIG. 2, may consist of text, a graphical image or set of graphical images, audio, video, video with audio, or any other digital representation of the advertiser's message. For example, in one embodiment of the invention, an advertisement is coded using conventional coding techniques and languages, such as hypertext markup language or HTML.

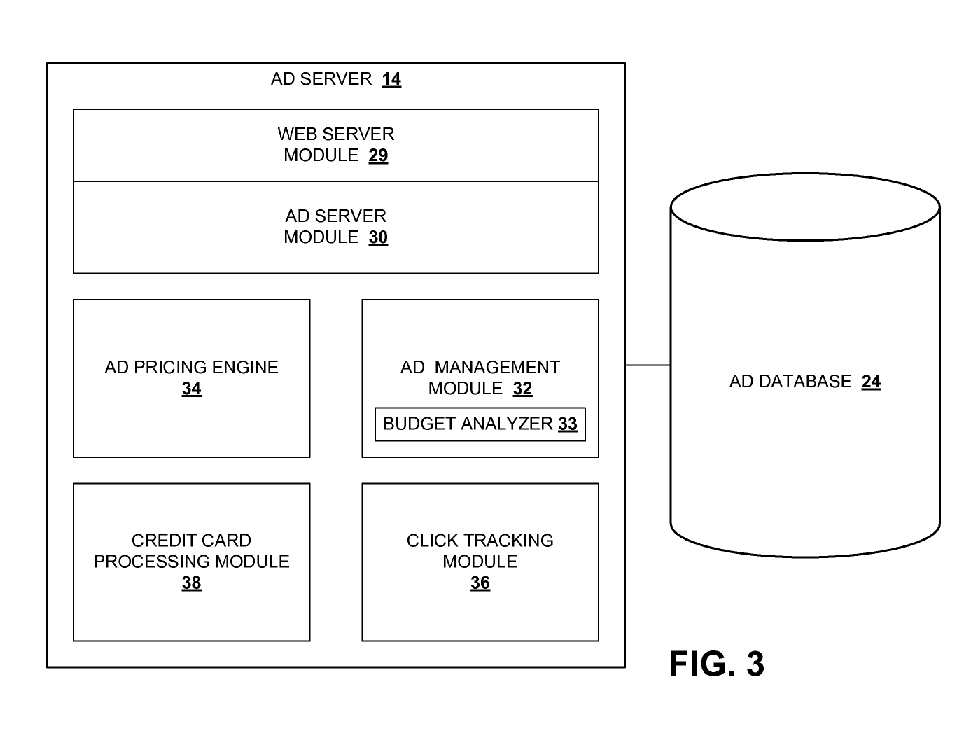

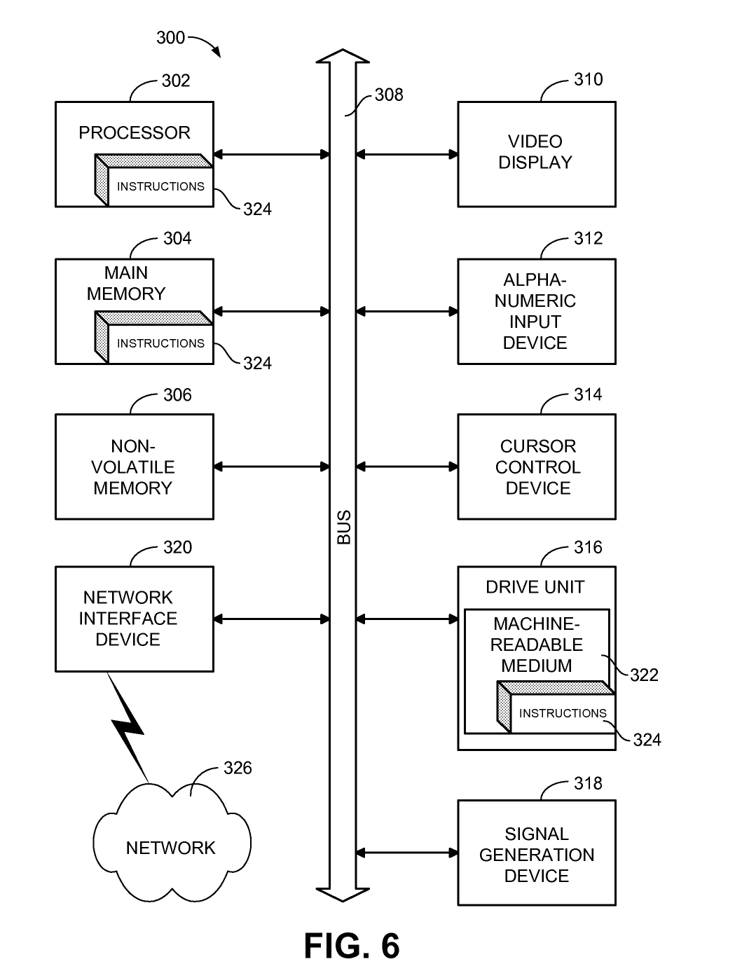

FIG. 3 illustrates a logical block diagram of an ad server 14, according to an embodiment. In one embodiment, an ad server 14 includes a web server component 29, an ad server module 30, an advertisement management module 32, an advertisement pricing engine 34, a click tracking module 36, and a credit card processing module 38. It will be appreciated by those skilled in the art that the various functional modules presented in FIG. 3 may be implemented in software, hardware, or a combination thereof. For example, a computer system such as that illustrated in FIG. 6 may be utilized to implement the particular functional blocks shown in FIG. 3. Furthermore, the particular functions provided by each module in FIG. 3 may be combined with other logical modules (not shown), which provide services that are tangential to those of the present invention.

In one embodiment, the ad server module 30 facilitates the serving of ads. For instance, when an end-user, utilizing a conventional web browser application, requests and receives an Internet document (e.g., web page), that document may include code that directs the web browser to request an advertisement from the ad server 14. Consequently, the ad server module 30 may receive and process the request. For example, the ad server module 30 may identify the particular advertisement that is to be served, read the particular advertisement from storage (e.g., advertisement database 24), and then serve the advertisement to the requesting browser application 22. Accordingly, in one embodiment, the ad server 14 is tightly integrated with the web server component 29. In an alternative embodiment, the ad server module 30 may function much the same way that a conventional web server functions. Moreover, in one embodiment, the ad server module 30 may be, or may include, a conventional web server component for serving ads.

The ad server 14 also includes an advertisement management module 32. In one embodiment, the advertisement management module 32 facilitates the generation and management of ads. For example, the advertisement management module 32 may include a user interface component, served by the web server component 29, which facilitates generating and/or modifying ads. In one embodiment of the invention, the advertisement management module 32 may also facilitate other administrative tasks associated with managing and configuring the ads. For example, via the advertisement management module 32, advertisers may be able to schedule times (e.g., days, weeks, months) when their advertisements are to be served to end-users.

In one embodiment, the advertisement management module 32 facilitates the linking of advertisements to particular keywords. For example, after an advertiser has generated an ad, the advertiser may utilize the advertisement management module 32 to link or associate the advertisement with one or more keywords. Consequently, the ad server 14 utilizes the keyword association to determine when the advertisement should be served. For example, the advertisement may be served when an end-user performs a keyword search that matches one or more keywords associated with the ad. Alternatively, the advertisement may be served when an end-user requests a web page that includes content (e.g., text) that matches one or more keywords. In the case of a keyword search, the actual keywords entered by the user may be forwarded from the web server handling the actual search (e.g., the publisher's web server 18) to the ad server 14. In the case of matching a web page's content, the ad server 14 may include a web crawler or other automated background application that analyzes the content of several web pages, and stores the analysis in a database.

In one embodiment, the advertisement management module 32 includes a budget analyzer 33. The budget analyzer 33 analyzes budget limits established by advertisers, and prevents advertisements from being served when a particular advertiser has reached its established budget limit for a predetermined budget period. Alternatively, the advertisements will be continued to be served, but the advertiser will not be charged (for the period remaining in the budget period), in response to an advertisement being selected by an end-user.

In one embodiment, the budget analyzer 33 may prevent advertisements from being served before the actual budget limit has been reached. For example, in the case when one more clicked advertisement will result in a debit that exceeds the budget limit, the budget analyzer 33 may prevent an advertisement from being served, thereby ensuring that the budget limit is not exceeded. Alternatively, when an advertiser is charged for serving an advertisement, in the case when one more served advertisement will result in a debit that exceeds the budget limit, the budget analyzer 33 may prevent an advertisement from being served, thereby ensuring that the budget limit is not exceeded.

In addition, the budget analyzer 33 may analyze the balance for each advertiser's account in order to keep sufficient funds available to serve ads. For example, in one embodiment, when an advertiser's account reaches a predetermined minimum level (e.g., such as three times the established daily budget), the budget analyzer 33 may cause the advertiser's credit card (or alternative methods of payment) to be charged. In one embodiment, when the predetermined minimum level is reached, the budget analyzer charges the advertiser's credit card (or alternative methods of payment) an amount equivalent to the billing increment, which may also be the amount originally deposited by the advertiser when initially establishing the account.

In one embodiment, the ad server 14 includes a click tracking module 36. The click tracking module 36 monitors when an advertisement that has been served is clicked. Accordingly, when the click tracking module 36 detects a click, the advertiser's account with which the advertisement is associated, is debited a predetermined amount. In one embodiment, the amount debited per click is determined based on the cost of the keywords. As the keywords are auctioned off, the popularity or demand for the keywords may play a role in establishing the price of the cost per click for each ad. For example, in one embodiment, the advertisement pricing engine 34 includes logic to facilitate electronic auctions for one or more keyword(s). Accordingly, as more participants bid on a particular keyword, the price for that keyword increases.

The ad server 14, according to one embodiment, also includes a credit card processing module 38. Accordingly, the credit card processing module 38 provides an interface to a third-party credit card processor, who handles transactions on behalf of the online advertisement service provider.

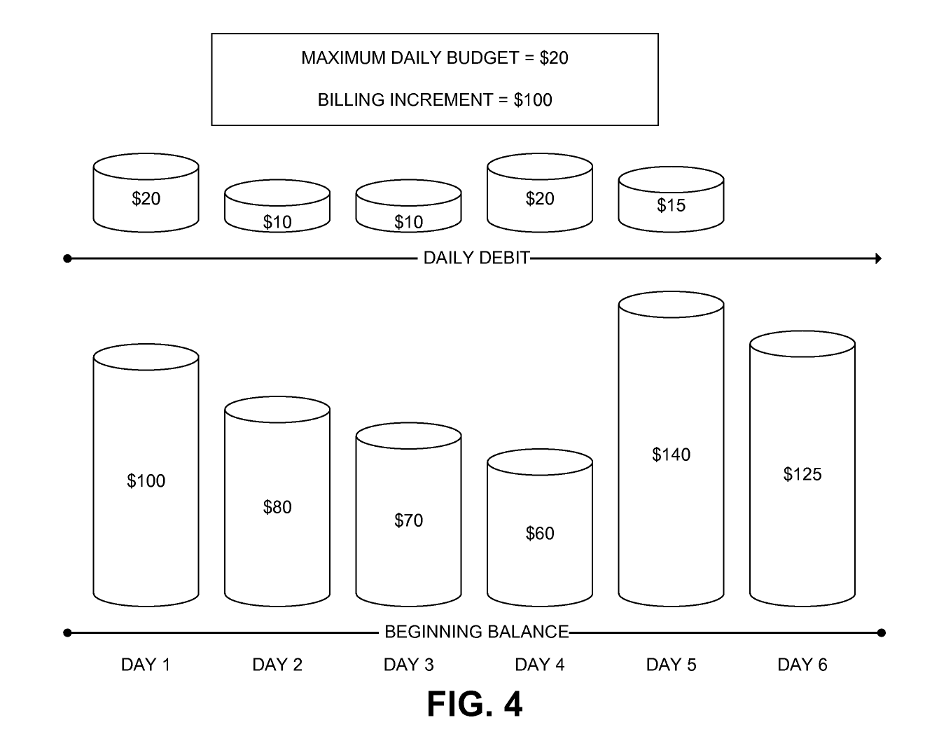

FIG. 4 illustrates a method for billing for advertisement services, according to an embodiment. As illustrated in FIG. 4, the advertiser has selected $20 as a maximum daily budget, and $100 as a billing increment. Accordingly, at day 1, the advertiser's beginning balance is $100. On day 1, the advertiser's advertisements are served and selected, such that the budget limit is reached. For example, over the course of day 1, the number of advertisements clicks causes the total amount of funds debited from the advertiser's account to reach $20. Consequently, the budget analyzer 33 prevents any additional advertisements from being served for that day.

On day 2, the beginning balance is $80 ($20 less than the previous day due to advertisements served and selected during day 1.) During day 2, the budget limit is not reached, but instead, $10 are debited from the account for advertisements served and selected. Consequently, the beginning balance on day 3 is $70. On day 3, $10 is debited for advertisements served and selected, and accordingly, the beginning balance on day 4 is $60.

On day 4, the daily budget, $20, is reached. Furthermore, the minimum balance is also reached, thereby triggering a charge in the amount of the billing increment, or $100. Consequently, after the $20 is debited for advertisements served on day 4, and $100 is deposited to replenish funds for the account, the beginning daily balance on day 5 is $140. Then, on day 5, $15 is debited from the account. Consequently, the beginning balance on day 6 is $125.

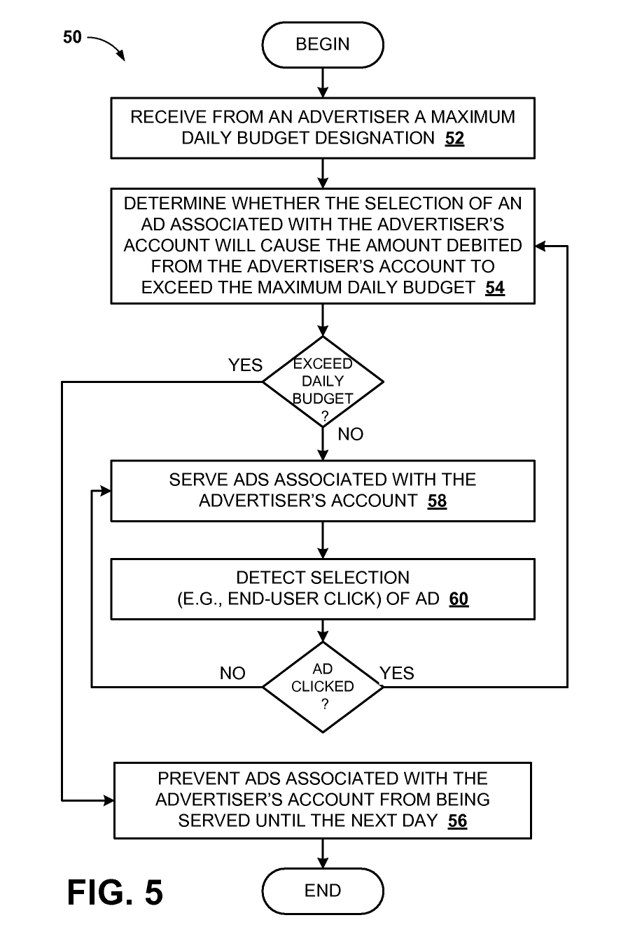

FIG. 5 illustrates the operations involved in a method 40 for billing for advertisement services, according to an embodiment of the invention. At operation 52, the ad server 14 receives, from an advertiser, a budget limit designation. In one embodiment, the advertiser also designates the budget period for the budget limit (e.g., a set of hours, one or more days, one or more weeks, etc.). By way of example, the advertiser may utilize a conventional web browser to interact with the ad server 14, and input an amount indicating the maximum amount that the advertiser desires to have debited from the advertiser's account in a given day. Next, at operation 54, the ad server 14 determines whether the selection of an advertisement by an end-user will cause the amount debited from the advertiser's account for the day to exceed the budget limit. If so, at operation 56, the ad server 14 prevents advertisements associated with the advertiser from being served, thereby ensuring that the advertiser's account is not debited an amount in excess of the advertiser's established budget limit for the particular budget period. Alternatively, the advertisements will be continued to be served, but the advertiser will not be charged (for the period remaining in the budget period), in response to an advertisement being selected by an end-user.

However, if the budget will not be exceeded with the selection of another advertisement by an end-user, the ad server 14 continues to serve ads, at operation 58. Then, at operation 60, the ad server 14 continues to monitor for the detection of advertisement clicks.

If the ad server detects an end-user selecting an ad, for example, by clicking it, then the click is processed. For example, the fee associated with the click is debited from the advertiser's account. Then, the method continues as the ad server 14 again determines whether the budget limit would be exceeded by the selection of an additional ad.

FIG. 6 shows a diagrammatic representation of a machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server (e.g., host 12) or a client 14 machine in a client-server network environment, or as a peer machine in a peer-to-peer (or distributed) network environment. The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Furthermore, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a nonvolatile memory 306, which communicate with each other via a bus 308. The computer system 300 may further include a video display unit 310 (e.g., a liquid crystal display (LCD). or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media. The software 324 may further be transmitted or received over a network 326 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and a system for billing for advertisement services have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method, comprising:
Identifying a budget limit an advertiser has authorized to be debited in a budget period, in connection with serving advertisements associated with the advertiser; and
Ceasing to cause debits to an advertiser's account for advertisements when a total amount debited in the budget period equals a predetermined amount, the predetermined amount equal to or less than the budget limit, wherein a predetermined amount of funds is to be debited when an advertisement associated with the advertiser is, at least one of, served or selected by an end-user.

2. The method of claim 1, wherein the budget period is equal to or less than a single day.

3. The method of claim 1, wherein the ceasing to cause debits includes ceasing to serve advertisements associated with the advertiser during a remaining period of the budget period.

4. The method of claim 1, wherein the ceasing to cause debits includes continuing to serve advertisements associated with the advertiser during a remaining period of the budget period without debiting funds from the advertiser in response to an advertisement being selected by an end-user.

5. The method of claim 1, wherein the budget period is equal to or less than a twenty-four hour period.

6. The method of claim 1, wherein the advertiser sets at least one of the budget limit and the budget period.

7. The method of claim 1, wherein the budget limit is expressed as an amount of currency per day.

8. The method of claim 1, further comprising:
detecting when an end-user has selected an advertisement associated with the advertiser;
debiting the predetermined amount of funds from an account held by the advertiser; and
determining whether debiting an additional predetermined amount will equal or exceed the budget limit.

9. The method of claim 1, wherein the account held by the advertiser is initially funded with an amount greater than the budget limit.

10. The method of claim 9, wherein an account held by the advertiser is automatically replenished with funds when the account balance becomes lower than a predetermined minimum level.

11. The method of claim 10, wherein the predetermined minimum level is determined as a multiple of the budget limit.

12. A system comprising:
Means for identifying a budget limit an advertiser has authorized to be debited in a budget period, in connection with serving advertisements associated with the advertiser; and
Means for ceasing to cause debits to an advertiser's account for advertisements when a total amount debited in the budget period equals a predetermined amount, the predetermined amount equal to or less than the budget limit, wherein a predetermined amount of funds is to be debited when an advertisement associated with the advertiser is, at least one of, served or selected by an end-user.

13. The system of claim 12, wherein the budget period is equal to or less than a single day.

14. The system of claim 12, wherein the means for ceasing to cause debits includes means for ceasing to serve advertisements associated with the advertiser during a remaining period of the budget period.

15. The system of claim 12, wherein the means for ceasing to cause debits includes means for continuing to serve advertisements associated with the advertiser during a remaining period of the budget period without debiting funds from the advertiser in response to an advertisement being selected by an end-user.

16. A machine-readable medium having stored thereon a set of instructions, which when executed perform a method comprising:
Identifying a budget limit an advertiser has authorized to be debited in a budget period, in connection with serving advertisements associated with the advertiser; and
Ceasing to cause debits to an advertiser's account for advertisements when a total amount debited in the budget period equals a predetermined amount, the predetermined amount equal to or less than the budget limit, wherein a predetermined amount of funds is to be debited when an advertisement associated with the advertiser is, at least one of, served or selected by an end-user, the account to be initially funded with funds equal to a multiple of the budget limit.

17. The machine-readable medium of claim 16, wherein the advertiser sets at least one of the budget limit and the budget period.

18. The machine-readable medium of claim 16, wherein the method further comprises:
detecting when an end-user has selected an advertisement associated with the advertiser;
debiting the predetermined amount of funds from an account held by the advertiser; and
determining whether debiting an additional predetermined amount will equal or exceed the budget limit.

19. The machine-readable medium of claim 18, wherein the account held by the advertiser is automatically replenished with funds when the account balance becomes lower than a predetermined minimum level.

20. The machine-readable medium of claim 19, wherein the ceasing to cause debits includes ceasing to serve advertisements associated with the advertiser during a remaining period of the budget period.
